(19) United States
(12) Patent Application Publication
(10) Pub. No.: US 2025/0357689 A1
(43) Pub. Date: Nov. 20, 2025

(54) PRESS-FIT CONNECTOR

(71) Applicant: Ennovi Industries, Inc., East Providence, RI (US)

(72) Inventors: Gregory TORIGIAN, Garnerville, NY (US); Matthew RUMSCHLAG, Hawthorn Woods, IL (US); Jason KSIAZK, Arlington Heights, IL (US)

(21) Appl. No.: 18/874,643

(22) PCT Filed: Jun. 13, 2023
(86) PCT No.: PCT/US2023/025171

§ 371 Date: Dec. 13, 2024

Related U.S. Application Data
(60) Provisional application No. 63/352,778, filed on Jun. 16, 2022.

(51) Int. Cl. H01R 12/58

(52) U.S. Cl. CPC H01R 12/585

(57) ABSTRACT

An assembly that includes a printed circuit board with a plated hole connected by a contact pin to a structure having a bore formed therein. The contact pin has a longitudinal axis and includes a blade section extending along the longitudinal axis. The contact pin has first and second fastening sections connected together by a link section. The first fastening section is press-fit into the bore of the structure and the second fastening section is press-fit into the plated hole of the printed circuit board. The first and second fastening structures may have the same or different widths.

### CROSS-REFERENCE TO RELATED APPLICATION(S)

This application claims the benefit of priority under 35 U.S.C. § 119(e) to U.S. Provisional Patent Application No.: 63/352,778 filed on 16 Jun. 2022, which is herein incorporated by reference.

### TECHNICAL FIELD

The present disclosure relates to an electrical contact and more particularly to a contact pin adapted to connect together a plurality of substrates.

### BACKGROUND

In electronic systems utilizing one or more PCBs, a PCB is often electrically connected to other electrical devices (such as other PCBs) by electrical connectors. In many instances, an electrical connector will utilize one or more contact pins that are fixed in electrically conductive hole(s) of the PCB. Such a contact pin may be secured within a hole of a PCB by soldering or by a retention feature of the contact pin. In the latter instance, the contact pin is typically referred to as a press-fit contact pin.

Conventionally, a press-fit contact pin includes a compliant fastening section that plastically and elastically deforms as it is inserted into the PCB hole. This deformation creates a retention force that holds the fastening section in the PCB hole. A number of different types of construction have been used for the fastening section, one of which is known as an “eye of the needle” (EON) type of construction. In this type of construction, a slot or opening is formed in the fastening section so as to define a pair of beams that are resiliently movable toward and away from each other to provide a normal force against the PCB hole, thereby providing a reliable electrical connection without the use of solder.

Conventional press-fit contact pins are used to connect a PCB to an electronic device that is to be mounted on the PCB. Conventional press-fit contact pins are not constructed to connect together two or more structures/devices. Moreover, conventional press-fit contact pins are not constructed to connect together misaligned structures/devices. As such, it would be desirable to provide a press-fit contact pin that can connect together more two or more structures/devices that are misaligned.

### SUMMARY

In accordance with the disclosure, an assembly is provided having a conductive contact pin and a printed circuit board disposed adjacent to a structure with a bore. The contact pin includes a blade section and a first fastening section connected by a link section to a second fastening section. The first fastening section has a first opening extending therethrough in a direction normal to the longitudinal axis so as to help form a pair of first beams. The first fastening section is press-fit into the bore of the structure so as to be fully disposed therein. The second fastening section is connected to the blade section and has a second opening extending therethrough in a direction normal to the longitudinal axis so as to help form a pair of second beams. The second fastening section is press-fit into a plated hole of the printed circuit board. No portion of the second fastening structure is disposed in the bore of the structure.

### BRIEF DESCRIPTION OF THE DRAWINGS

The features, aspects, and advantages of the present invention will become better understood with regard to the following description, appended claims, and accompanying drawings where:

FIG. 1 shows a perspective view of a contact pin of a first embodiment;

FIG. 2 shows a side view of the contact pin of FIG. 1;

FIG. 3 shows a front view of the contact pin of FIG. 1;

FIG. 4 shows a front view of a contact pin of a second embodiment;

FIG. 5 shows a perspective sectional view of an assembly having a contact pin connecting together a printed circuit board and a heat sink;

FIG. 6 shows a front sectional view of an assembly having a contact pin in the process of being connected to a printed circuit board and an adjoining heat sink;

FIG. 7 shows a front sectional view of the assembly of FIG. 6 in which the contact pin is fully connected to the printed circuit board and the heat sink; and

FIG. 8 shows a side sectional view of an assembly having a contact pin in the process of being mounted to a printed circuit board and an adjoining heat sink.

### DETAILED DESCRIPTION OF ILLUSTRATIVE EMBODIMENTS

It should be noted that in the detailed descriptions that follow, identical components have the same reference numerals, regardless of whether they are shown in different embodiments of the present disclosure. It should also be noted that for purposes of clarity and conciseness, the drawings may not necessarily be to scale, and certain features of the disclosure may be shown in somewhat schematic form.

The present disclosure is directed to a method and apparatus for securing together a pair of structures having holes formed therein. The structures may be a pair of printed circuit boards (PCBs), a PCB and another structure, or a pair of other types of structure. The method and apparatus are for use with structures having holes that are aligned or mostly aligned with each other. Indeed, the method and apparatus have particular utility for use with structures where the holes in the structures are not completely aligned.

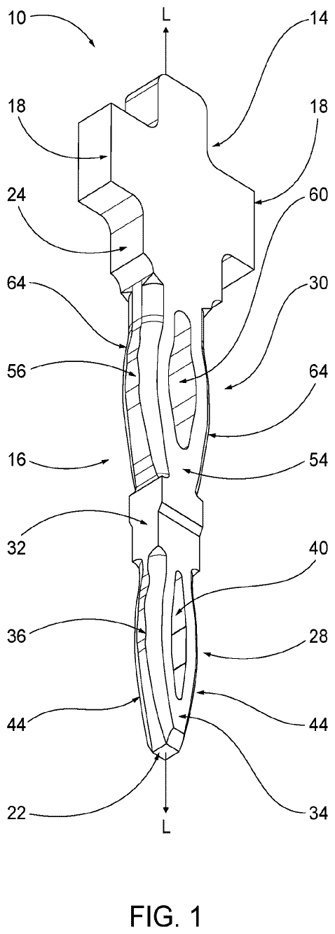

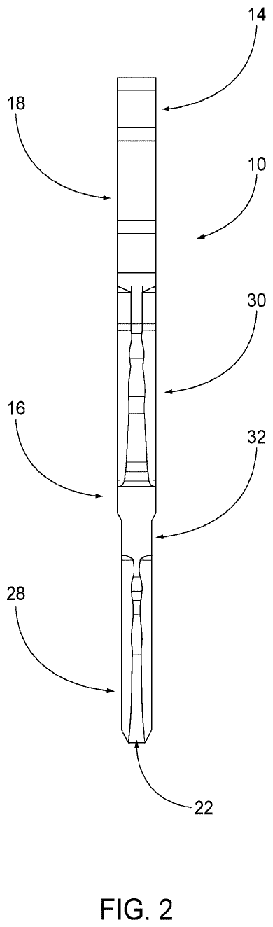

Referring now to FIGS. 1-3, there is shown an embodiment of a contact pin 10 constructed in accordance with this disclosure. The contact pin 10 is a unitary structure and is comprised of a conductive metal (such as a tin-plated copper alloy) and is elongated, having a longitudinal axis L. The contact pin 10 includes a blade section 14 integrally joined to a fastening section 16. The blade section 14 may have different configurations. For example, the blade section 14 may have shoulders 18 and further include a pin adapted for insertion into a female connector (not shown) so as to make an electrical connection therewith. The pin may have a free end that is tapered to facilitate insertion. Depending on the application, the blade section 14 may, in addition to the shoulders 18, have one or more additional retention structures, such as large stars and smaller elongated stars (not shown) arranged around the circumference of a retention area, proximate to the shoulders 18. The retention area may have a diameter larger than the pin. The shoulders 18 and any additional retention structures may be used to secure the contact pin 10 to a connector housing or other type of component or part. The shoulders 18 may also function as stops against which a force may be applied to insert the fastening section 16 into holes of a plurality of substrates.

The fastening section 16 includes a tip 22 and a neck 24. The tip 22 has a planar face and is solid, i.e., an axial bore does not extend through the face. The face is disposed in a plane perpendicular to the longitudinal axis L. The tip 22 may be beveled around the entire periphery of the face, or only between the face and major surfaces, or only between the face and side surfaces. The neck 24 is joined to the blade section 14, such as at the shoulders 18. In between the tip 22 and the neck 24, there are two or more deformable sections, such as first deformable section 28 and second deformable section 30. The first and second deformable sections 28, 30 are connected together by a link section 32 and are arranged serially in the direction of the longitudinal axis L. The first and second deformable sections 28, 30 may have the same or different configurations and dimensions, as described more fully below. As such, the first and second deformable sections 28, 30 may have the same or different deformation profiles in the direction of the longitudinal axis L.

The first deformable section 28 has opposing major surfaces 34 that extend in the direction of the longitudinal axis L, between the tip 22 and the link section 32, respectively. Opposing side surfaces 36 also extend in the direction of the longitudinal axis L between the link section 32 and the tip 22, respectively, and are joined between the major surfaces 34. Each of the side surfaces 36 is arcuate in the longitudinal direction, as well as in the normal direction. The side surfaces 36 may be fully arcuate (rounded) in both the longitudinal direction and in the normal direction, or they may have portions that are straight. The major surfaces 34 may be substantially flat and disposed in planes that are parallel with the longitudinal axis L. However, one or both of the major surfaces 34 may be partially flat and partially tapered, and the tapered portion may be flat or curved. The major surfaces 34 join the side surfaces 36 at rounded edges, respectively.

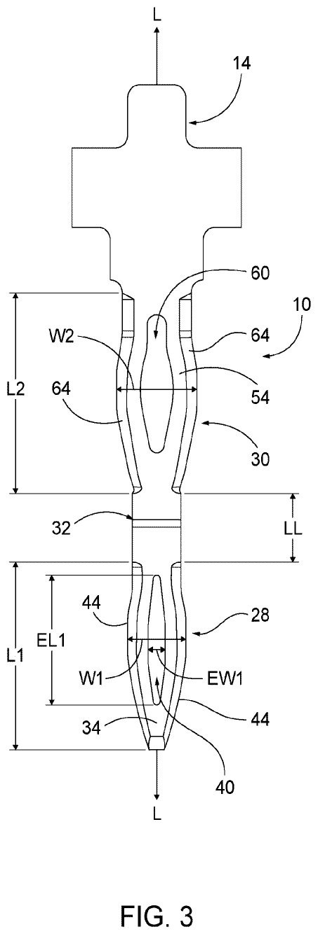

As best shown in FIG. 3, the first deformable section 28 has a maximum width at its center of W1 and a length L1. In some embodiments, W1 may be in a range of from about 1 mm to about 4 mm, more usually in a range of from about 1 mm to about 2 mm, more usually about 1.5 mm. The length L1 may be in a range of from about 2 mm to about 8 mm, more usually in a range from about 3 to about 6 mm.

An opening or eye 40 extends through the major surfaces 34, respectively, in the normal direction. The eye 40 has the shape of an elongated ellipse and is defined by an elliptical inner wall that extends linearly in the normal direction. The eye 40 helps define a pair of beams 44. The eye 40 is substantially symmetrical about both the longitudinal axis L and an axis normal to the longitudinal axis that extends through the beams 44 at the center of the eye 40. The eye 40 has a maximum width EW1 at its center and a length of EL1, between its longitudinally spaced ends. In some embodiments, EW1 may be in a range of from about 0.2 mm to about 2 mm, more usually in a range of from about 0.3 mm to about 1.0 mm. The length EL1 may be in a range of from about 2 mm to about 6 mm. The ratio of EL1/EW1 may be in a range of from about 3 to about 6.

The beams 44 are joined at the tip 22 and the link section 32, and are separated by the eye 40. The beams 44 are resiliently movable toward and away from each other. This resiliency permits the beams 44 to move toward each other when the first deformable section 28 is being inserted into a hole of a substrate and then, when they are disposed in the hole, to exert outwardly-directed forces against an interior wall of the hole so as to retain the first deformable section 28 in the hole. The round shape of the tip 22, the arcuate contours of the side surfaces 36, and the rounded edges joining the side surfaces 36 to the major surfaces 34 all facilitate the insertion of the first deformable section 28 into the hole and help prevent damage to the substrate around the hole.

The link section 32 may have an angular structure with an outer cuboidal portion connected by opposing sloping surfaces to a larger inner cuboidal portion. The link section 32 has a length LL that is selected to provide a desired distance between the eye 40 and an eye 60 of the second deformable section 30.

The second deformable section 30 has opposing major surfaces 54 that extend in the direction of the longitudinal axis L, between the link section 32 and the neck 24, respectively. Opposing side surfaces 56 also extend in the direction of the longitudinal axis L between the link section 32 and the neck 24, respectively, and are joined between the major surfaces 54. Each of the side surfaces 56 is at least partially arcuate in the longitudinal direction, as well as in the normal direction. The side surfaces 56 may be fully arcuate (rounded) in both the longitudinal direction and in the normal direction, or they may have portions that are straight. The major surfaces 54 may be substantially flat and disposed in planes that are parallel with the longitudinal axis L. However, one or both of the major surfaces 54 may be partially flat and partially tapered, and the tapered portion may be flat or curved. The major surfaces 54 may be disposed outwardly from the major surfaces 34 of the first deformable section 28, i.e., the second deformable section 30 may be thicker than the first deformable section 28, as shown. However, in some embodiments, the second deformable section 30 may have the same thickness as the first deformable section 28. The major surfaces 54 join the side surfaces 56 at rounded edges, respectively.

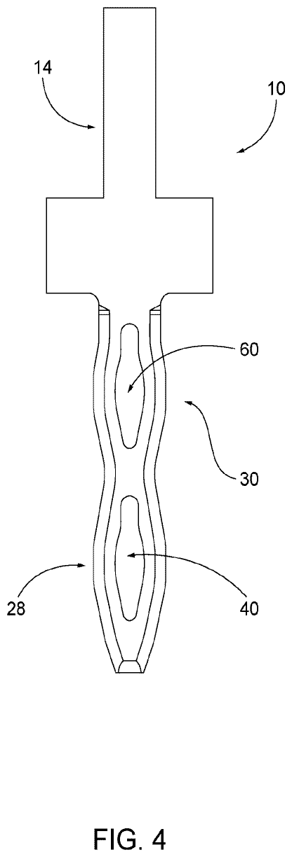

The second deformable section 30 has a maximum width at its center of W2 and a length L2. The length L2 may be about the same as length L1, namely in a range of from about 2 mm to about 8 mm, more usually in a range from about 3 to about 6 mm. W2 may be the same as W1 (as shown in FIG. 4), or may be greater than W1 (as shown in FIGS. 1-3 and 6-7). In some embodiments W2 may be in a range of from about 1 mm to about 4 mm, more usually in a range of from about 1 mm to about 2 mm, more usually about 1.5 mm. The ratio of W2/W1 may be in a range from about 1.0 to about 1.5.

An opening or eye 60 extends through the major surfaces 54, respectively, in the normal direction. The eye 60 may have the shape of an ellipse or an irregular ellipse. The eye 60 helps define a pair of beams 64. In the embodiment where the eye 60 is elliptical, the eye 60 is substantially symmetrical both in the direction of the longitudinal axis L and an axis normal to the longitudinal axis that extends through the beams 64 at the center of the eye 60. In the embodiment where the eye 60 has an irregular elliptical shape, the eye 60 is symmetrical in the longitudinal direction, but is asymmetrical in the normal direction between the beams 64.

The beams 64 are joined at the link section 32 and the neck 24, and are separated by the eye 60. The beams 64 are resiliently movable toward and away from each other. This resiliency permits the beams 64 to move toward each other when the second deformable section 30 is being inserted into a hole of a substrate and then, when they are disposed in the hole, to exert outwardly-directed forces against an interior wall of the hole so as to retain the second deformable section 30 in the hole. The arcuate contours of the side surfaces 56, and the rounded edges joining the side surfaces 56 to the major surfaces 54 all facilitate the insertion of the second deformable section 30 into the hole and help prevent damage to the substrate around the hole.

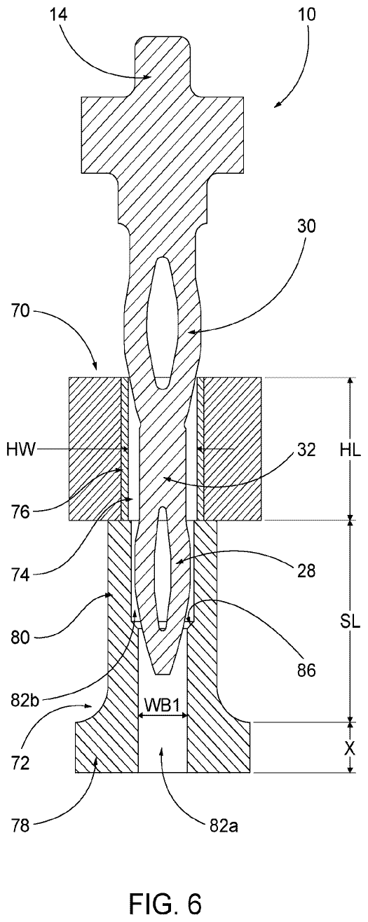

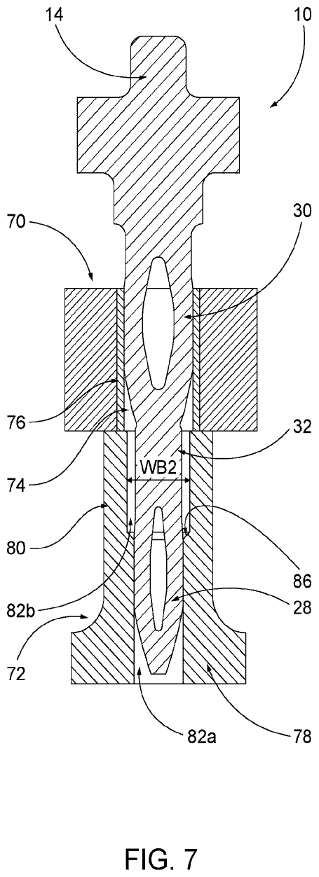

As shown in FIGS. 1-3, the second deformable section 30 may be wider than the first deformable section 28 and the eyes 40, 60 may have different configurations. FIG. 4 shows the first and second deformable sections 28, 30 as having the same size and eye configuration. FIGS. 6-7 show the second deformable section 30 being wider than the first deformable section 28 and the eyes 40, 60 as having the same elliptical configuration, but different dimensions.

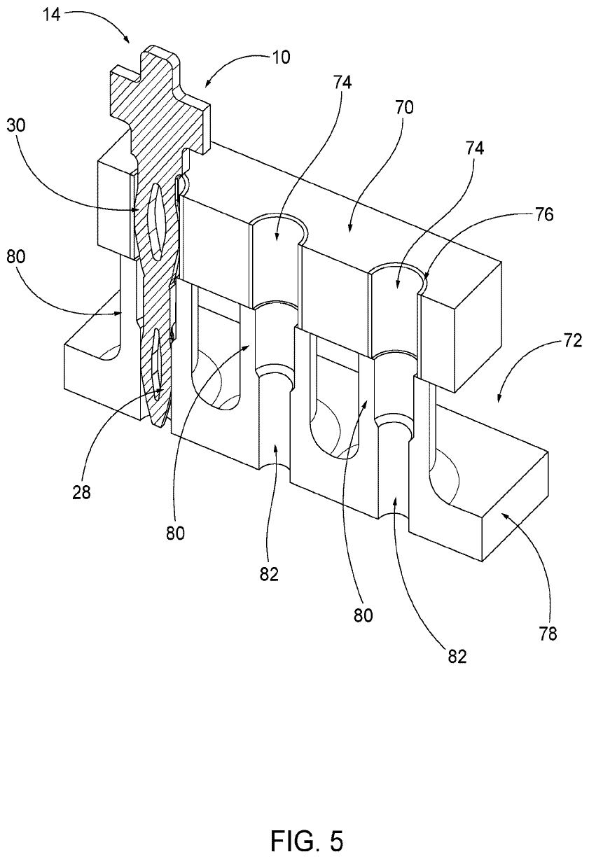

Referring now to FIGS. 5-7, one or more contact pins 10 may be used to electrically, thermally and physically connect together a PCB 70 and a heat sink 72. The PCB 70 has one or more through-holes 74 with inner metal platings 76. Each through-hole 74 has a length HL and a width HW, which may less than, equal to, or greater than the width W1 of the first deformable section 28 of the contact pin 10. The width HW, however, is less than the width W2 of the second deformable section 30. The heat sink 72 may include a main body 78 and one or more cylindrical standoffs 80. The standoffs 80 help form a space between the PCB 70 and the main body 78. The standoffs 80 and the main body 78 may be separate pieces that are secured together, or they may be integrally joined together to be portions of a unitary structure. The main body 78 and the standoffs 80 may each be comprised of steel, brass, copper, aluminum or an aluminum ceramic, such as aluminum nitride. If the standoffs 80 are separate pieces, the standoffs 80 may have the same or different compositions. The heat sink 72 has a plurality of bores 82, with each bore 82 extending through a standoff 80. The bores 82 may be straight or stepped and may be threaded or smooth.

FIGS. 6-7 show the embodiment where the bores 82 are stepped so as to have a first bore portion 82a and a second bore portion 82b. The first bore portion 82a has a diameter or width WB1, while the second bore portion 82b has a diameter or width WB2. The width WB2 is greater than the width WB1. The width WB1 is slightly less than the width W1 of the first deformable section 28. The first and second bore portions 82a,b meet at a sloping annular shoulder 86. The first bore portion 82a extends through an inner portion of the stand off 80 and into the body 78. The standoff 80 has a length SL and the main body 78 may have a thickness X.

The dimensions of the components of the heat sink 72 and the PCB 70 help determine the dimensions and configuration of the contact pin 10. For example, the length HL of the through-hole 74 will help determine the length L2 of the second deformable section 30. Similarly, the length SL of the standoff 80 and the thickness X of the main body 78 help determine the length L1 of the first deformable section 28. The length LL of the link section 32 (separating the first and second deformable sections 28, 30) is determined by a number of factors including the dimensions HL, SL, X, L1 and L2.

In the embodiment where the bores 82 are stepped, the location of the shoulder 86 may be determined by the timing of the entrance of the second deformable section 30 into the through-hole 74 and the entrance of the first deformable section 28 into the first bore portion 82a. More specifically, the second deformable section 30 may engage the plating 76 of the through-hole 74 just before the first deformable section 28 engages the interior wall defining the first bore portion 82a, as shown in FIG. 6.

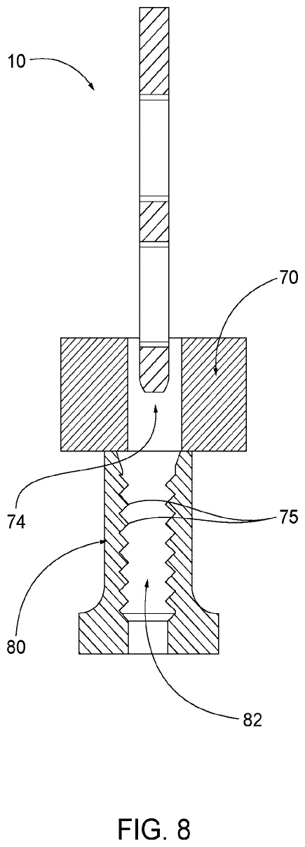

FIG. 8 shows an embodiment where the bores 82 each have an interior wall with projections 75 extending therefrom. The projections 75 may be turns of one or more helical threads, spaced-apart annular ridges, or other types of projections. The thread(s) may be singular or multi-start threads. When the contact pins 10 are moved into the bores 82 of the heat sink 72, the projections 75 engage the beams 44 of the first deformable sections 28, thereby helping hold the first deformable sections 28 inside the bores 82, respectively.

In FIG. 8, the projections 75 in each bore 82 are shown extending for most of the length of the bore 82. In other embodiments, the projections 75 may extend along a smaller portion of the bore 82. For example, the bore 82 may be stepped and the projections may only be located in the first bore portion 82a.

The PCB 70 and the heat sink 72 are connected together by first (substantially) aligning the through-holes 74 of the PCB 70 with the bores 82 of the heat sink 72. The PCB 70 and the heat sink 72 are held firmly in place as the contact pins 10 are pressed into position such that the first deformable sections 28 of the contact pins 10 are moved through the through-holes 74 of the PCB 70 and thence into the bores 82 of the heat sink 72. If the width W1 of the first deformable sections 28 is greater than the width HW of the through-holes 74 in the PCB 70, the first deformable sections 28 will deform and move through the through-holes 74 and into the bores 82. If the width W1 of the first deformable sections 28 is less than the width HW of the through-holes 74, the first deformable sections 28 will not deform and will move facilely through the through-holes 74 and into the bores 82.

If the beams 44 are not already pressed together after passing through the through-holes 74 in the PCB 70, the beams 44 are pressed together as the first deformable sections 28 move into the bores 82, respectively. Inside the bores 82, the beams 44 apply laterally outward forces against the interior walls that frictionally secure the first deformable sections 28 within the bores 82. Similarly, as the second deformable sections 30 move into the through-holes 74 of the PCB 70, the plating 76 defining the through-holes 74 cause the beams 64 to move laterally inward toward each other. Inside the through-holes 74, the beams 64 apply laterally outward forces against the plating 76 to frictionally secure the second deformable sections 30 within the through-holes 74. In this manner, the first deformable sections 28 are secured inside the heat sink 72 and the second deformable sections 30 are secured inside the PCB 70, thereby securing together the heat sink 72 and the PCB 70 so as to adjoin each other. As shown in FIGS. 5 and 7, each second deformable section 30 is mostly or fully disposed inside its corresponding through-hole 74 in the PCB 70 and each first deformable section 28 is fully disposed inside its corresponding bore 82 in the heat sink 72. The blade section 14 may be secured to another device or structure, thereby resulting in the interconnection of three structures/devices. The connection of the blade section 14 to another device may be electrical (and mechanical), such as for the conveyance of an electrical signal. In contrast, the connection of the PCB 70 to the heat sink 72 by the contact pin 10 is thermal (and mechanical). Thus, the contact pin 10 makes mechanical, electrical and thermal connections.

In connecting together the PCB 70 and the heat sink 72, the centerlines of the through-holes 74 in the PCB 70 may be slightly offset from the centerlines of the bores 82 in the heat sink 72 when the contact pins 10 are inserted into the through-holes 74 and the bores 82. The construction of the contact pins 10 allows the contact pins 10 to bend slightly to accommodate the offset and still be firmly connected to the PCB 70 and the heat sink 72.

It is to be understood that the description of the foregoing exemplary embodiment(s) is (are) intended to be only illustrative, rather than exhaustive. Those of ordinary skill will be able to make certain additions, deletions, and/or modifications to the embodiment(s) of the disclosed subject matter without departing from the spirit of the disclosure or its scope.

What is claimed is:

1. An assembly comprising:
a printed circuit board having a hole;
a structure having a bore, the structure being disposed adjacent to the printed circuit board;
an electrically conductive contact pin having a longitudinal axis and comprising:
a blade section extending along the longitudinal axis;
a first fastening section having a first opening extending therethrough in a direction normal to the longitudinal axis so as to help form a pair of first beams, the first fastening section being press-fit into the bore of the structure so as to be fully disposed therein;
a second fastening section connected to the blade section and having a second opening extending therethrough in a direction normal to the longitudinal axis so as to help form a pair of second beams, the second fastening section being press-fit into the plated hole of the printed circuit board; and
a link section connecting the first fastening section to the second fastening section; and
wherein no portion of the second fastening structure is disposed in the bore of the structure.

2. The assembly of claim 1, wherein an interior wall of the structure forms the bore and wherein the interior wall has projections extending therefrom.

3. The assembly of claim 2, wherein the first fastening section engages the projections inside the bore.

4. The assembly of claim 3, wherein the projections in the bore are turns of one or more helical threads.

5. The assembly of claim 1, wherein the structure and the printed circuit board are in physical contact with each other.

6. The assembly of claim 1, wherein the second fastening section is press-fit into the plated hole of the printed circuit board so as to be fully disposed therein.

7. The assembly of claim 1, wherein the bore of the structure is stepped so as to have a first bore portion and a second bore portion, wherein the first bore portion has a diameter smaller than a diameter of the second bore portion.

8. The assembly of claim 7, wherein a majority of the first fastening section of the contact pin is disposed in the first bore portion.

9. The assembly of claim 8, wherein the structure has an interior wall that helps define the bore and wherein the interior wall has projections extending therefrom, the projections being located in the first bore portion;
wherein the first fastening section engages the projections inside the bore; and
wherein the projections are turns of one or more helical threads.

10. The assembly of claim 1, wherein the second fastening section is thicker than the first fastening section in a direction perpendicular to the longitudinal axis.

11. The assembly of claim 1, wherein the structure is a heat sink.

12. The assembly of claim 11, wherein the heat sink comprises aluminum.

13. The assembly of claim 1, wherein the printed circuit board has a plurality of holes;
wherein the structure has a plurality of interior walls, each of which forms a bore, the interior walls each having projections extending therefrom; and
wherein the assembly comprises a plurality of electrically conductive contact pins, each having a longitudinal axis and comprising:
a blade section extending along the longitudinal axis;
a first fastening section having a first opening extending therethrough in a direction normal to the longitudinal axis so as to help form a pair of first beams;
a second fastening section connected to the blade section and having a second opening extending therethrough in a direction normal to the longitudinal axis so as to help form a pair of second beams; and
a link section connecting the first fastening section to the second fastening section;
wherein the first fastening sections are press-fit into the bores of the structure so as to be fully disposed therein and so as to engage the projections therein, respectively;
wherein the second fastening sections are press-fit into the plated holes of the printed circuit board, respectively; and
wherein no portions of the second fastening structures are disposed in the bores of the structure.

14. The assembly of claim 13, wherein the structure is a heat sink and comprises a main body with a plurality of stand-offs extending therefrom, and wherein each of the bores extends through one of the stand-offs.

15. The assembly of claim 14, wherein the stand-offs space the main body of the heat sink from the printed circuit board.

16. A method of forming an assembly, comprising:
(a.) providing a printed circuit board having a hole;
(b.) providing a structure having a bore;
(c.) providing an electrically conductive contact pin having a longitudinal axis and comprising:
a blade section extending along the longitudinal axis;
a first fastening section having a first opening extending therethrough in a direction normal to the longitudinal axis so as to help form a pair of first beams;
a second fastening section connected to the blade section and having a second opening extending therethrough in a direction normal to the longitudinal axis so as to help form a pair of second beams; and
a link section connecting the first fastening section to the second fastening section;
(d.) positioning the structure and the printed circuit board to be disposed adjacent to each other and such that the hole of the printed circuit board is at least partially aligned with the bore of the structure;
(e.) inserting the contact pin into the hole of the printed circuit board and the bore of the structure until the first fastening section is press-fit into the bore of the structure so as to be fully disposed therein and the second fastening section is press-fit into the plated hole of the printed circuit board with no portion of the second fastening structure being disposed in the bore of the structure, thereby completing the insertion.

17. The method of claim 16, wherein the hole is lined with metal plating;
wherein the bore of the structure is stepped so as to have a first bore portion and a second bore portion, wherein the first bore portion is defined by an interior wall and has a diameter smaller than a diameter of the second bore portion; and
wherein as the contact pin is inserted into the hole of the printed circuit board and the bore of the structure, the second fastening structure engages the plating of the hole before the first fastening section engages the interior wall defining the first bore portion.

18. The method of claim 17, wherein when the insertion of the contact pin is complete, a majority of the first fastening section of the contact pin is disposed in the first bore portion.

19. The method of claim 16, wherein the structure has an interior wall that helps define the bore and wherein the interior wall has one or more helical threads formed therein; and
wherein during the insertion of the contact pin, the first fastening section engages the one or more helical threads inside the bore.

20. The method of claim 19, wherein the positioning of the structure and the printed circuit board is performed to have the structure and the printed circuit board in physical contact with each other.
